(19) United States
(12) Patent Application Publication
(10) Pub. No.: US 2012/0284195 A1
(43) Pub. Date: Nov. 8, 2012

(54) METHOD AND SYSTEM FOR SECURE USER REGISTRATION

(76) Inventors: Glenn Curtiss McMillen, Downingtown, PA (US); David A. Crake, Newark, DE (US); Garry Lloyd, Northampton (GB)

(21) Appl. No.: 13/100,610

(22) Filed: May 4, 2011

(51) Int. Cl. G06Q 20/36; G06Q 20/10

(52) U.S. Cl. 705/71; 705/41

(57) ABSTRACT

A method and system are described for registering an online account associated with a mobile device configured for contactless payment operations in a mobile payment account system. The method includes generating, by a mobile device, a passcode based at least on an encryption key stored securely in the mobile device. In a computing device, a registration process is initiated to register the online account. The computing device receives user input data identifying a passcode generated by the mobile device. An online account server stores online account data defining a user account associated the mobile device, the online account data including a data defining an encryption key. The online account server receives user input data identifying the passcode generated by the mobile device, generates a passcode based at least on the encryption key stored in the online account server, compares the received generated passcode to the passcode generated by the online account server, and verifies the user account associated the mobile device when the generated passcodes match.

### FIELD OF THE INVENTION

This invention relates to a mobile payment account system. More particularly, the invention relates to an improved process of provisioning of a mobile payment account on a mobile device and management of associated digital documents.

### BACKGROUND OF THE INVENTION

Mobile payment account systems are generally known, in which portable electronic devices are configured to provide payment from an electronic wallet. Typically, these portable electronic devices are configured to enable a contactless communication with a merchant Point Of Sale (POS) terminal to carry out a payment transaction, for example, using near field communication (NFC) technology. As described in the commonly owned co-pending U.S. patent application Ser. No. 12/891,866, entitled “METHOD AND SYSTEM FOR ELECTRONIC WALLET ACCESS”, filed Oct. 15, 2010 ('866 application), and U.S. patent application Ser. No. 12/905,419, entitled “MOBILE PAYMENT SYSTEM”, filed Sep. 28, 2010 ('419 application), both of which are incorporated herein by reference in their entirety, activated mobile payment account data can be stored in the secure element of the portable electronic device which can then be used to carry out transactions with the merchant electronic POS terminal via a NFC link. Systems described in the above-referenced '866 application and '419 application advantageously provide the customer with the ability to apply for a payment product that, once approved, is immediately provisioned and activated on the mobile device, thus allowing the customer to immediately make purchases using the activated mobile payment account. As described in the '866 application, provisioning of a mobile payment account, in response to an instant provisioning request from the mobile device, involves creation and communication of data for the mobile payment account to the mobile device. Activation of the mobile payment account provisioned on the mobile device typically involves authentication of the user before the mobile payment account is enabled for use in the mobile payment system.

Systems for online banking via the Internet are also generally known that provide the user with an online account for access to the user's bank account information and account related functions, such as transferring funds from the user's bank account to another bank account, using a web browser on a computing device in communication with a suitably configured web server at the financial institution.

It is an object of the invention to provide a system that integrates a mobile payment account sub-system and an online banking sub-system in a secure manner.

### SUMMARY OF THE INVENTION

In one aspect of the present invention, a mobile payment account system is provided comprising a mobile device configured for contactless payment operations from a mobile payment account. The mobile device includes a secure element storing a wallet application module, data defining an encryption key, and data associated with the mobile payment account. The mobile device also includes a mobile-side passcode generator adapted to generate a first passcode based at least on the encryption key. The system also comprises an online account server including a memory storing online account data defining a user account associated with the mobile device. The online account data comprises data defining a corresponding encryption key. The system further includes a communication interface adapted to receive user input data identifying the first passcode generated by the mobile device. A server-side passcode generator is adapted to generate a second passcode based at least on the encryption key stored in the online account server. The system also includes a user validator adapted to compare the first and second passcodes for a match in a registration process to register the user account.

In another aspect of the present invention, a computer implemented method is provided for registering an online account associated with a mobile device configured for contactless payment operations in a mobile payment account system. The method comprises a online account server performing computer-implemented step of storing online account data defining a user account associated the mobile device. The online account data comprises data defining the same encryption key. The method further includes employing the online account server in the performance of receiving user input data identifying a first passcode generated by the mobile device based at least on an encryption key stored in the mobile device; generating a second passcode based at least on an encryption key stored in the online account server; comparing the first passcode to the second passcode to determine a match; and registering the online account when a match is determined.

In yet another aspect of the present invention, a computer implemented method is provided for registering an online account associated with a mobile device configured for contactless payment operations in a mobile payment account system. The method comprises a computing device performing the computer-implemented step of initiating a registration process to register an online account associated with a mobile device; receiving user input data identifying a first passcode generated by the mobile device; and transmitting the first passcode to a online account server for registering the online account when the online account server determines that the first passcode matches a second passcode generated by the online account server based at least on an encryption key stored in the online account server.

In yet a further aspect there is provided a computer program arranged to carry out the above method when executed by components of a mobile payment system.

### BRIEF DESCRIPTION OF THE DRAWINGS

There now follows, by way of example only, a detailed description of embodiments of the present invention, with references to the figures identified below.

FIG. 1 is a block diagram showing the main components of a mobile payment system according to an embodiment of the invention;

FIG. 2 is a block diagram showing the main hardware and/or software elements of a mobile device shown in FIG. 1 according to an embodiment;

FIG. 3 is a flow diagram illustrating the main processing steps performed by the mobile device of FIGS. 1 and 2 in a process for applying for a new mobile payment account product according to an embodiment;

FIG. 4, which comprises FIGS. 4a to 4f, illustrates a sequence of screens displayed by the mobile device to the user during the process of applying for a new mobile payment account product; and

FIG. 5 schematically illustrates a digital document structure for facilitating enhanced monitoring and tracking of user navigation through the document, according to an alternate embodiment of the present invention.

### DETAILED DESCRIPTION OF THE INVENTION

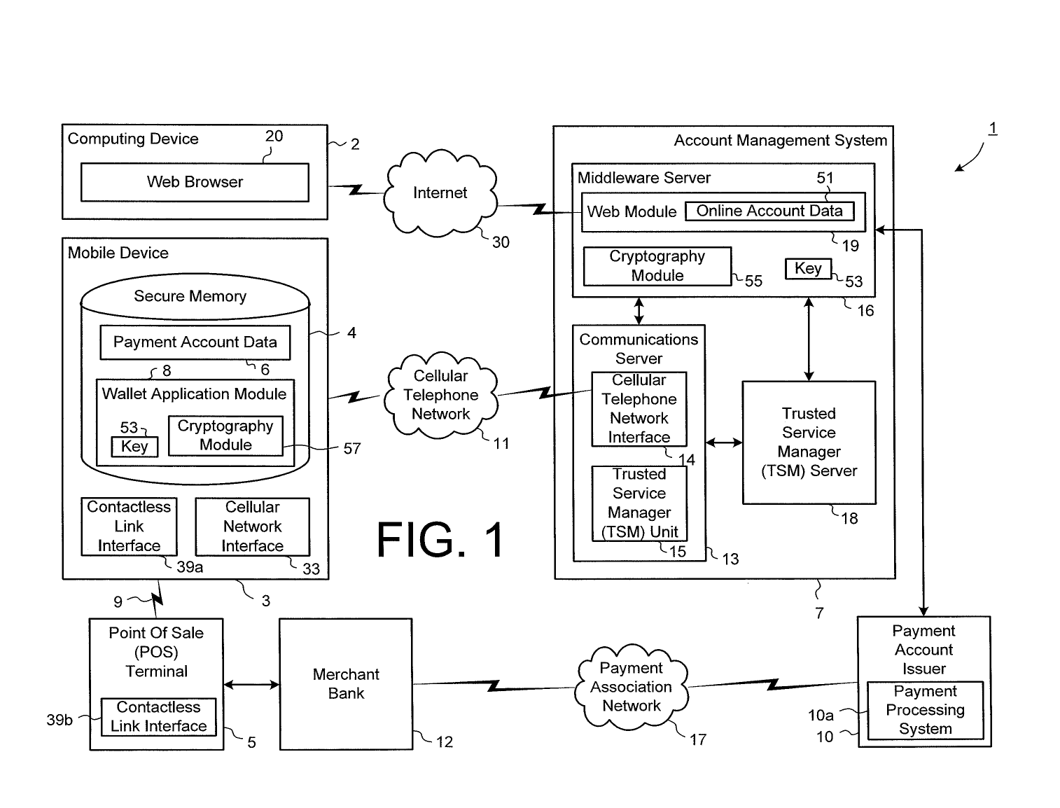

Referring to FIG. 1, a mobile payment system 1 comprises a mobile device 3, a merchant's electronic Point Of Sale (POS) terminal 5 as commonly known in the field, and an account management system 7 associated with a payment account issuer 10. The mobile device 3, merchant's electronic POS terminal 5, and the account management system 7 associated with the payment account issuer 10 communicate electronically with one another. The account management system 7 provides for mobile payment account creation and activation, transaction authorization, and other related functionalities, as described in the above-referenced co-pending U.S. patent application Ser. Nos. 12/891,866 and 12/905,419.

As will be described below in greater detail, the account management system 7 functions as an online account server that includes a communications server 13, a Trusted Service Manager (TSM) server 18, and a middleware server 16 working in conjunction to facilitate communication with the mobile device 3. The payment account issuer 10 includes a payment processing (authorization and fraud monitoring) system 10a for authorizing and effecting payment transactions from payment accounts associated with the payment account issuer 10 in response to payment transaction instructions received via a payment association network 17.

In accordance with a preferred embodiment, the mobile device 3 and the electronic POS terminal 5 communicate with one another over a contactless communication link 9 via respective contactless communication interfaces 39a, 39b. It is appreciated this contactless communication link 9 may be a near field communication (NFC) link, an infra-red link, an ultra-sonic link, an optical link, a radio frequency (eg. RFID) link, a wireless link such as Bluetooth or Wi-Fi based on the IEEE 802.11 standards, or any other communication link that does not require direct physical contact. The mobile device 3 can communicate with the account management system 7 over a cellular telephone network 11 via a cellular network interface 33.

As shown in FIG. 1, the mobile device 3, that is, an electronic wallet as the term is used herein, includes a secure element 4 storing payment account data (that is, electronic wallet data) 6 for one or more mobile payment accounts that have been set up on the mobile device 3. The secure element 4 can be a Universal Integrated Circuit Card (UICC) secure element, any other secure memory configuration, such as an embedded secure element chip, or as part of a peripheral accessory device to the mobile device 3, such as a micro Secure Digital card—otherwise known as a micro SD card, as are known in the art. Other forms of mobile handset software and/or hardware can be implemented to provide built-in secure electronic wallet functionality for accessing the secure element 4, including encryption and decryption of the payment account data 6, as necessary. The mobile device 3 is configured with built-in functionality providing access to the secure element 4.

In accordance with a preferred embodiment as shown with reference to FIG. 1, payment account data 6 for a mobile payment account that is securely stored in the mobile device 3 includes data identifying a user's account at a payment account issuer 10 from which funds can be transferred to the merchant bank to complete a transaction via a payment association network 17. The payment account data 6 can additionally include data defining an amount of pre-paid funds that have been transferred from the user's payment account issuer 10 to that mobile payment account. In this way, the electronic wallet can include a payment account linked to multiple funding sources, such as a pre-paid account, deposit account and/or credit account. As an alternative, the electronic wallet can include a plurality of mobile payment accounts, each linked to a respective funding source.

The mobile device 3 also includes a wallet application module 8 storing processing instructions. In accordance with a preferred embodiment of the present invention processing instructions are computer-implementable instructions. The processing instructions are used to control the operation of the mobile device 3, to facilitate the application for and management of one or more mobile payment accounts on the mobile device 3 and to handle the process of conducting a transaction with a merchant via the electronic POS terminal 5. The transaction with a merchant via the electronic POS terminal 5 is facilitated using a mobile payment account on the mobile device 3 to effectively transfer funds from the mobile payment account on the mobile device 3, or an associated payment account issuer 10, to the merchant.

The wallet application module 8 can be implemented as one or more software components of an operating system running on the mobile device 3 or implemented as one or more separate software applications installed on the mobile device 3. In this embodiment, the wallet application module 8 comprises an authentication application for validating a user to activate a provisioned mobile payment account, and a payment application for facilitating payment transactions using an activated mobile payment account. The software applications can be configured to run as background applications on the mobile device 3 that monitor receipt of messages or events and activate upon receipt of appropriate messages or events so as to carry out the above operations. The software applications can alternatively be launched by the user. Alternatively, the wallet application module 8 is stored in the secure element 4, and is loaded into a virtual machine of the mobile device 3 to provide the functionality of the present embodiment.

A secure mobile payment account provisioning and activation process can be carried out between the mobile device 3 and the account management system 7, as described in the above referenced '866 application. The activated mobile payment account data stored in the secure element 4 of the mobile device 3 is then used to carry out transactions with a merchant electronic POS terminal 5 via the contactless communication link 9, whereby a requested amount of funds is transferred from the mobile payment account stored in the mobile device 3 to the merchant's bank 12. Techniques and protocols for implementing the authorization and transfer of funds between the merchant POS terminal 5, the merchant bank 12, and the payment account issuer 10 via the payment association network 17 are well known to those skilled in the art and are therefore not described further herein.

In this embodiment, a user associated with the one or more mobile payment accounts configured on the mobile device 3 is provided with an online account configured at the account management system 7 to facilitate secure online access to information and account management services in a secure manner via the Internet 30. The account management system 7 additionally provides for secure registration of the user's online account after a mobile payment account has been provisioned on the user's mobile device 3. As illustrated in FIG. 1, the user can register and store online account data 51 in a web module 19 of the middleware server 16 of the account management system 7 via a computing device 2 including a web browser 20 that is able to communicate data to and from the web module 19 over one or more networks, for example, the Internet 30 in accordance with the embodiment described herein. In an alternative embodiment, the mobile device 3 may instead be configured to include a web browser 20 for facilitating the online account registration process. It is appreciated that although the web module 19 is provided in the middleware server 16 in the exemplary embodiment, the web service functionality of the web module 19 may instead be provided in a separate web server in the account management system 7.

As will be described in more detail below, the registration process uses information that is stored securely on the account management system 7 and the mobile device 3, which is not transmitted over the Internet 30 or the cellular telephone network 11. This secure information is an encryption key 53 that is securely stored in the middleware server 16 of the account management system 7. The same encryption key 53 is stored in the secure element 4 of the mobile device 3, for example, as data securely embedded in a wallet application module 8. A passcode generator, in particular, a cryptography module 55 in the middleware server 16, uses the encryption key 53 to generate a one-time passcode that is used to verify the user during the online account registration process. The cryptography module 55 may also be configured to generate the one-time passcode based on additional information such as the user's Mobile Directory Number (MDN), a hardware identifier of the mobile device, and/or a time-based element such as a session identifier. The one-time passcode is generated using known technology, for example, via a counter or cryptogram generator, and the one-time passcode expires based upon the passing of a time period set at the web module 19. The generated passcode may take any respective form, and may be composed of numeric or alphabetic symbols, non-alphanumeric symbols, or a combination of such symbols. A similar passcode generator, in particular, a cryptography module 57, is provided in the secure element 4 of the mobile device 3, for example, as executable processing instructions in the wallet application module 8, for generating the same one-time passcode. The cryptography module 55 in the middleware server 16, may instead be provided as a separate unit in the account management system 7 with a secure communication path to the web module 19, and the cryptography module 57 in the mobile handset 3 may instead be provided as a separate application module or hardware unit in the secure element 4.

In this way, the account management system 7 is able to advantageously provide for secure and efficient user registration of an online account, associated with the user's mobile payment accounts. In this way the account management system 7 ties the mobile solution to the web channel, reduces the ability for fraudsters to compromise customer identification and verification (ID&V) information through malicious software at end user computing devices because the web registration process no longer requires use of a physical plastic card, information (e.g. the CVV value) or ID&V information. The online account registration process also advantageously performs a two-factor authentication prior to registration by utilizing information that must be present and available (the mobile device 3 with the encryption key 53) as well as information that is known only to the user (for example, a user configured PIN as will be described below). This further reduces payment account compromise by malicious code.

The account management system 7 in the mobile payment system 1 will now be described in more detail with reference to FIG. 1, which shows the elements of the account management system 7 used in embodiments of the present invention. The account management system 7 includes a communications server 13, a middleware server 16, and a TSM server 18, which communicate electronically with one another. The communications server 13, middleware server 16, and TSM server 18 communicate with one another via secure network links over a private Local Area Network (LAN), a Virtual Private Network (VPN) connection, or other dedicated secure connection. It is appreciated that, although the components of the account management system 7 in this embodiment are provided as separate servers, one or more of the servers could be provided as software and/or hardware modules in the same server.

As shown in FIG. 1, the data is communicated between the mobile device 3 and the middleware server 16 over the cellular telephone network 11 via a cellular telephone network interface 14 of the communications server 13. The TSM server 18 performs logical data preparation of the data to be communicated to the mobile device 3 by forming appropriate commands to be written to the secure element 4 of the mobile device 3. The precise form of the data depends on the particular implementation of the secure element 4 of the mobile device 3 and/or the payment association scheme program for facilitating payment. The TSM server 18 can also perform encryption of the data, for example, of the sensitive payment account information, for example, payment keys, in the mobile payment account data 6. The TSM server 18 then passes the encrypted data to the mobile device 3 via the communications server 13 and the cellular telephone network 11.

In the exemplary embodiment shown in FIG. 1, the communications server 13 includes a separate TSM unit 15 for establishing a trusted communication channel with a mobile device 3 via the cellular telephone network 11, and for securely routing the data to the mobile device 3. In the above example, the TSM unit 15 in the communications server 13 would not access any of the sensitive portions of the encrypted data that are routed to the mobile device 3 via the cellular telephone network interface 14. It is appreciated that the functionality of the TSM unit 15 may be integrated with the cellular telephone network interface 14.

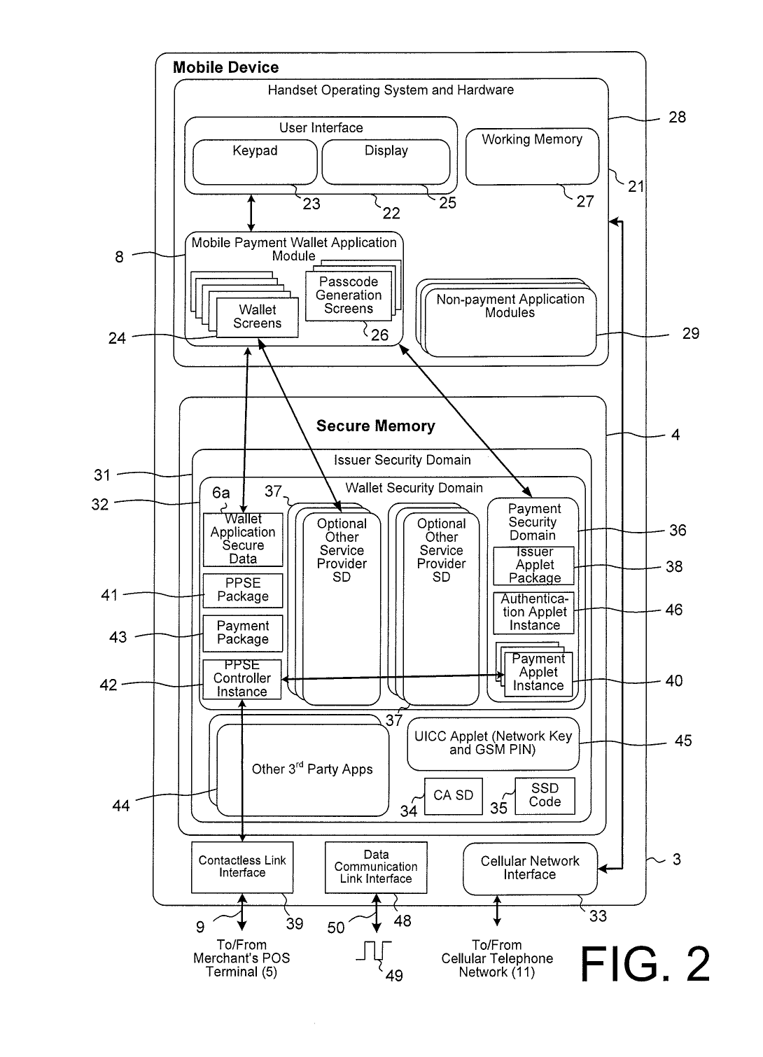

FIG. 2 shows the elements of a mobile device 3 according to an embodiment of the present invention. In this embodiment, the mobile device 3 is a mobile handset. As shown in FIG. 2, the mobile handset operating system and hardware includes a user interface 22 arranged to process inputs from a keypad 23 and to control output on a display 25. The keypad 23 and display 25 may be provided as separate hardware entities of the mobile device 3, or alternatively, as an integrated entity such as a touch sensitive display screen user interface. The mobile device 3 can also include components included in commonly known mobile handsets, such as a microphone, an earpiece speaker, a camera and a controller, and/or a GPS receiver etc., which are not shown. A working memory 27 is provided for use by the handset operating system and hardware units 21.

Software and data are transferred via the cellular network interface 33 or via a different data communication link interface 48 in the form of signals 49, which may be electronic, electromagnetic, optical, or other signals capable of being received by the data communication link interface 48 via a communication path 50 that carries the signals 49 and may be implemented using wire or cable, fiber optics, a physical phone line, a wireless link, a radio frequency link, or any other suitable communication channel, including any combination of suitable communication channels. The communication path 50 can be linked or merged with the communication path from the cellular network interface 33 to the cellular telephone network 11.

As mentioned above, the mobile device 3 includes a secure element 4. The mobile device 3 is operable to receive the payment account data 6 and activation request messages from and send validation messages to the account management system 7 via the cellular telephone network interface 33 and the cellular telephone network 11. The mobile device 3 is also operable to store the received payment account data 6 in the secure element 4. The mobile device 3 is also operable to receive transaction authorization request messages from and send authorization messages to the merchant's POS terminal 5 via the contactless communications link interface 39 and the contactless communication link 9. Communication between a POS terminal 5 and the mobile device 3 can involve transmission of data in a single direction from the mobile device 3 to the POS terminal 5, depending on an implemented protocol (such as the well known protocol used by the Discover Zip™ cashless payment system).

The mobile device 3 also includes a wallet application module 8 as mentioned above. The wallet application module stores processing instructions used to control the operation of the mobile device 3 to perform various mobile payment account processes. The wallet application module 8 includes an account creation sub-module and an account activation sub-module. The account creation sub-module and the account activation sub-module store processing instructions to create a request for a new mobile payment account if desired and to carry out a secured account validation and activation processes in response to user input from the keypad 23 as described in the above-referenced '866 application. The wallet application module 8 also includes a transaction authorization sub-module which stores processing instructions used to control the operation of the mobile device 3 to carry out and authorize a transaction in response to user input from the user interface 22, as described in the above-referenced '419 application. The wallet application module 8 is configured to store a plurality of wallet screens 24 which may be output on the display 25 of the user interface 22 to facilitate user interaction with the sub-modules of the wallet application module 8. One wallet screen is a main menu displaying a list of user selectable options, for example, to access and manage payment account data 6 of a selected mobile payment account stored on the mobile device 3. In this embodiment, a plurality of “online registration” wallet screens 26 are provided in the wallet application module 8 which are displayed in response to user selection of an option to register an online account associated with a mobile payment account. The mobile device 3 also stores one or more non-payment application modules 29 including processing instructions used to control the operation of the mobile device 3 to perform other non-payment related processes.

Also schematically illustrated in the exemplary embodiment of FIG. 2 are security domains which can be implemented in the secure element 4 of the mobile device 3. The secure element 4 is advantageously implemented to be compliant with one or more specifications of a standard infrastructure in order to facilitate communication of data and messages between the mobile device 3 (and the secure element 4) and other entities in the mobile payment system 1. For example, and in accordance with a preferred embodiment, the secure element 4 is compliant with the known GlobalPlatform Card Specifications (for example the “GlobalPlatform Card Specification 2.2”, March 2006), and accordingly includes a plurality of security domains for facilitating control of the management of and accessibility to executable operations and sensitive data associated with specific areas of the secure element 4 by the various entities in the mobile payment system 1. The GlobalPlatform Card Specifications define a hierarchical arrangement of security domains, each defining functionality and data that can be accessed by a respective associated entity, for example, cryptographic keys or certificates, that can be used to support secure channel protocol operations between the mobile device 3 and the entity or entities associated with that particular security domain, and/or to authorize secure element 4 content management functions.

As shown in the exemplary embodiment of FIG. 2, an issuer security domain 31 associated with a particular mobile network operator, includes a wallet security domain 32 associated with the payment account issuer 10, a Controlling Authority (CA) security domain 34 associated with a controlling authority in the mobile payment system 1, and a Supplementary Security Domain (SSD) code 35 associated with an intermediate security domain (not shown) to manage card content and perform cryptographic services for confidentiality. The wallet security domain 32 in this exemplary embodiment includes wallet application secure data 6a, which includes data for use by the wallet application module 8. The wallet security domain 32 also includes a payment security domain 36 and one or more optional other service provider security domains 37. The payment security domain 36 includes an issuer applet package 38, an authentication applet instance 46, and one or more payment applet instances 40 which enable the transaction processing functionality using an activated mobile payment account. The payment account data 6 (not shown in FIG. 2 for clarity) is also securely stored in the payment security domain 36. The wallet security domain 32 also includes a Proximity Payment System Environment (PPSE) package 41, defining application functionality associated with transaction processing functionality and, in particular, for handling communications with a contactless reader of the POS terminal 5 to identify which of the one or more mobile payment accounts is to respond

The wallet security domain 32 also includes a PPSE controller instance 42 for accessing the application functionality in the PPSE package 41 to facilitate an additional application layer level of control of the transaction processing functionality between the one or more payment applet instances 40 and the contactless communications link interface 39. In particular, the PPSE package 41 and controller instance 42 are advantageously provided where the mobile device 3 stores a plurality of mobile payment accounts and operates to communicate with the NFC reader of the merchant POS terminal 5 to control which one of the payment applet instances 40, associated with a respective mobile payment account stored on the mobile device 3, is to respond back to the POS reader.

Each security domain will be associated with one or more respective entities in the mobile payment system 1 depending on the particular business model that is implemented by the system. The specific implementation details of the various security domains for compliance with, for example, the GlobalPlatform Card Specifications are outside the scope of this application and will be apparent to the skilled reader. The mobile device 3 also includes one or more other third party application modules 44 stored in the secure element 4, for example an application module related to a third party loyalty scheme. The secure element 4 also stores a UICC applet 45 which is an application to manage and hold the mobile network operator's functionality and secure information, such as a network key and GSM (Global Systems for Mobile Communications) PIN (Personal Identification Number).

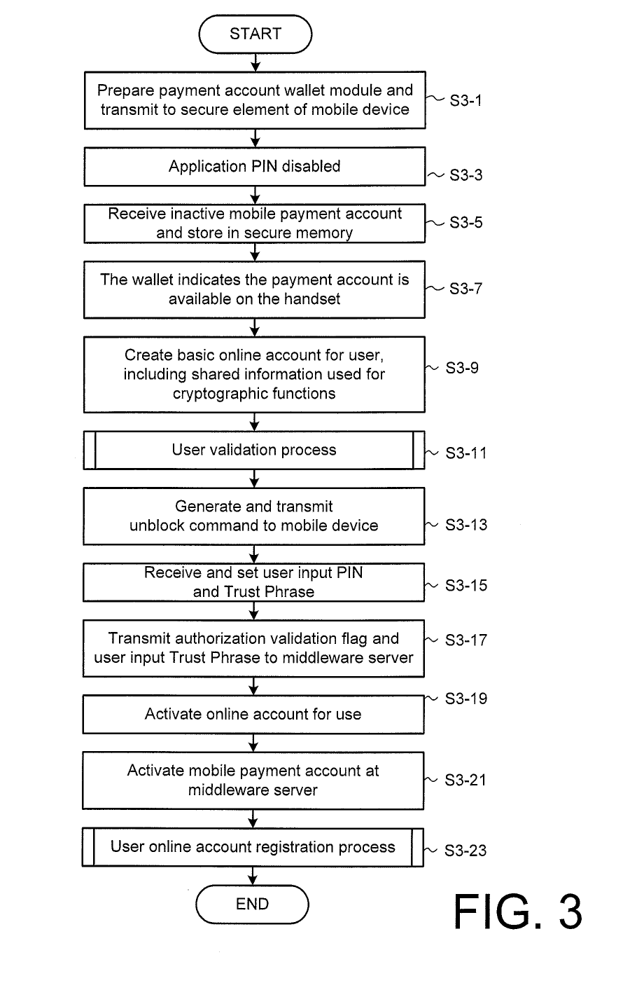

A brief description has been given above of the components forming part of the mobile payment system 1. A more detailed description of the operation of these components in this embodiment will now be given with reference to the flow diagram of FIG. 3. FIG. 3 describes a computer-implemented process for provisioning and activating a mobile payment account using the mobile device 3 in communication with the account management system 7, and for creating, activating and securely registering an associated online account. As shown in FIG. 3, the process begins at step S3-1 where the wallet application module 8, including the authentication and payment applications, are prepared by the account management system 7 and transmitted to the secure element 4 of the mobile device 3 via the cellular telephone network 11 as discussed above. The wallet application module 8 is provided with a security mechanism for accessing the application data, by way of user verification data, for example, a user configurable application PIN in this embodiment. Accordingly, the first time the wallet application module 8 is received and stored in the mobile device 3, the requirement for input of an application PIN to access the wallet application module 8 is disabled as illustrated by step S3-3 because the user has yet to configure a PIN for the application. It is appreciated that the application PIN may take any respective form, and may be composed of numeric or alphabetic symbols, non-alphanumeric symbols, or a combination of such symbols. In alternative embodiments, other forms of user identification and user verification data can be used to verify and validate a user wishing to access the wallet application module 8, such as using biometrics including one or more of finger or hand print scanning, face recognition, DNA profiling, iris or retina recognition, voice recognition, and drawl pattern matching.

At step S3-5, payment account data 6 for an inactive mobile payment account is received by the mobile device 3 and stored in the secure element 4. The payment account data 6 may be received by the mobile device 3 via any appropriate data communication channel or mechanism. Once the payment account data 6 has been stored in the secure element 4, the wallet application module 8 displays, at step S3-7, an indication that an inactive mobile payment account is available for activation on the mobile device 3. As discussed above, the user is provided with an online account associated with the mobile payment account. The web module 19 of the account management system 7 creates an online account (accessible via the Internet) for the user at step S3-9. The online account may initially include basic information associated with the user and the online account such as a unique account name or identification number of the user's mobile device (for example a unique Mobile Directory Number of the mobile handset), as well as shared information (for example, the shared encryption key 53) that is used for cryptographic functions when the user registers the online account as will be discussed later. A user may preferably be associated with a single online account that is associated with each of the user's one or more mobile payment accounts. Alternatively, the user may be associated with one online account for each mobile payment account.

At step S3-11, a user validation process is conducted in response to the user launching the wallet application module 8 and selecting the inactive mobile payment account to activate. An exemplary user validation process involving a sequence of identification and verification questions is described in the above referenced '866 application, although any alternative process may be used to validate the user of the mobile device 3 via the wallet application module 8. Once the user has been validated at step S3-11, the middleware server 16 generates and transmits an unblock command to the wallet application module 8 of the mobile device 3, at step S3-13. Upon receiving the unblock command, the wallet application module 8 prompts the user to enter an application issuer PIN and a trust phrase, which are securely stored in the wallet application module 8 in the secure element 4 at step S3-15. After the user input application issuer PIN has been set, the wallet application module 8 in the mobile device 3 transmits, at step S3-17, an authorization validation flag and the user input trust phrase to the middleware server 16 of account management system 7 via the secure and trusted communication connection established by the communications server 13. The middleware server 16 then communicates the received user input to the web module 19 to securely store the user input trust phrase in the online account data associated with online account created for that user at step S3-9. At step S3-19, the web module 19 activates the online account by configuring data identifying a state of the online account to indicate that the online account is ready for registration by the user.

At step S3-21, the middleware server 16 activates the mobile payment account and transmits an indication to the mobile device 3 that the mobile payment account is activated for conducting contactless transactions via the mobile device 3. In this embodiment, the user is prompted to proceed with the online account registration process as illustrated by step S3-23. The user may be directed to an appropriate web page URL to proceed with the registration process in any known manner, via a wallet screen 24 displayed by the mobile device and/or by an e-mail automatically generated and sent by the web module 19 to an e-mail address previously provided by the user.

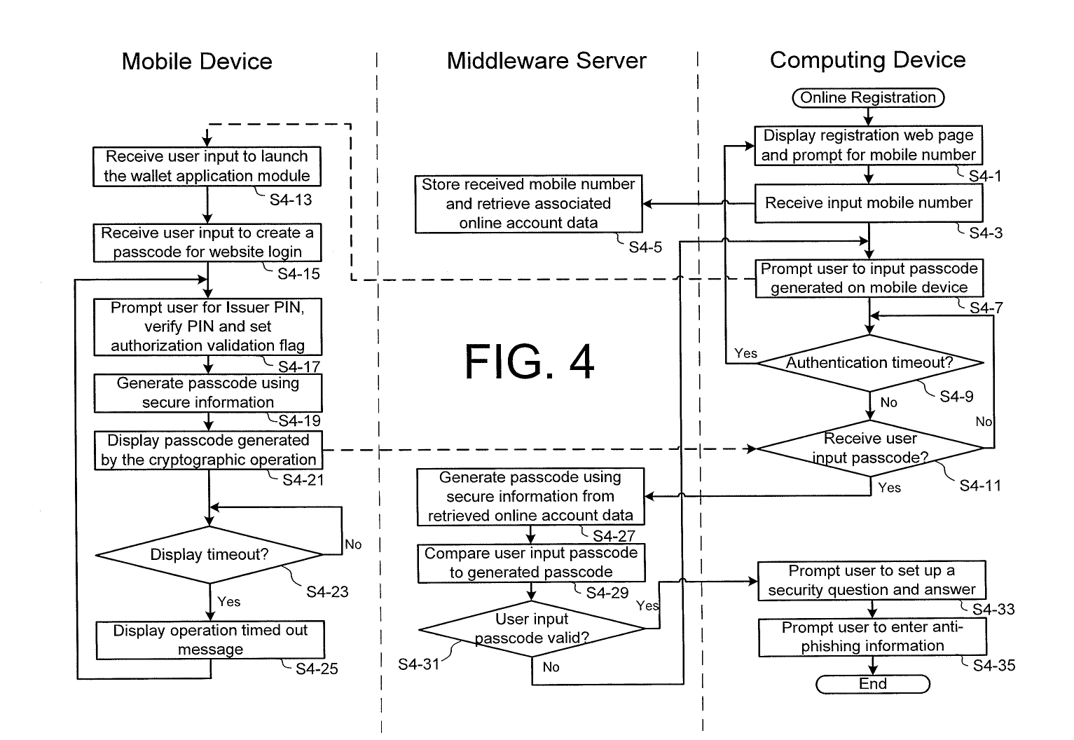

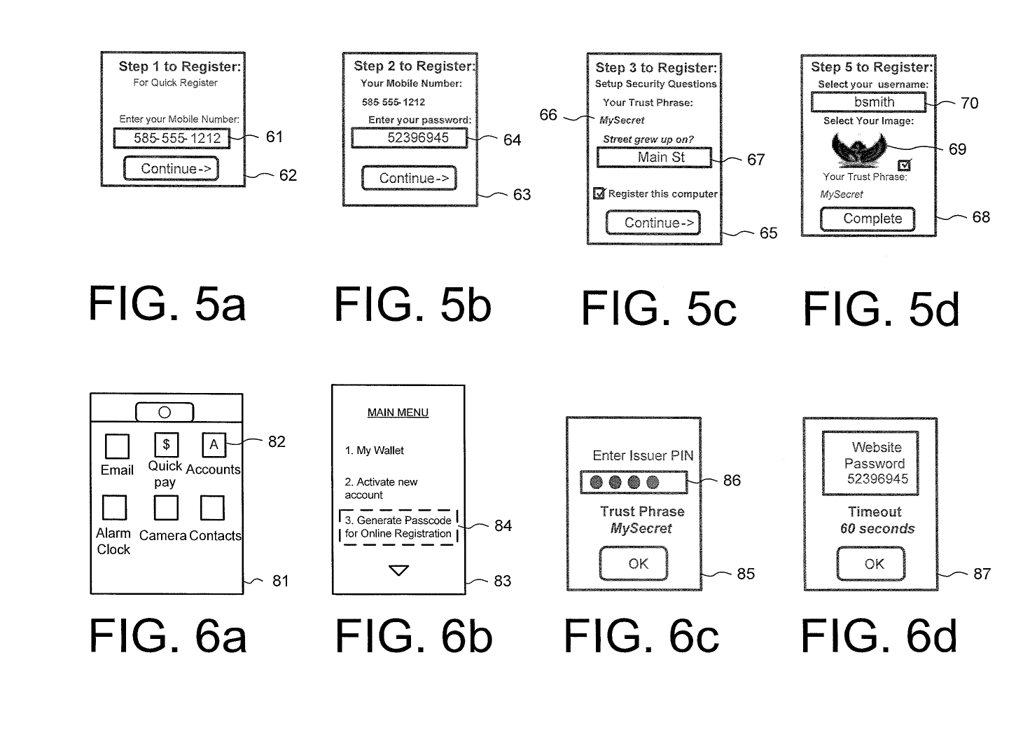

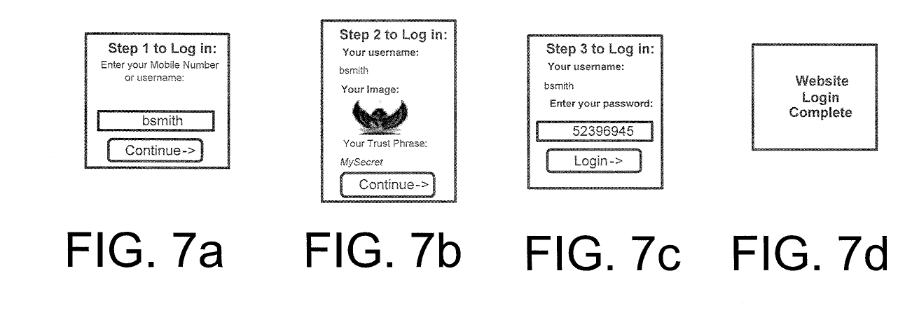

The online account registration process will now be described in more detail with reference to FIG. 4. Reference is also made to FIG. 5, which comprises FIGS. 5a to 5d, schematically illustrating exemplary display screens that can be presented to a user on the mobile device 3 in the online account registration process, and to FIG. 6, which comprises FIGS. 6a to 6d, schematically illustrating exemplary display pages that can be presented to a user via the web browser 20 on the computing device 2 in the online account registration process.

The online account registration process begins with the user launching the web browser 20 of the computing device 2 and requesting the registration web page from the web module 19 of the account management system 7 as prompted at step S3-23 discussed above. In response to requesting the registration web page via the appropriate URL, the registration web page is received and displayed to the user at step S4-1, as illustrated in FIG. 4. In this embodiment, the web page is configured to prompt the user to enter a MDN, for example, as an input box 61 of the web page 62 as schematically illustrated in FIG. 5a. At step S4-3, the user enters a MDN, and the user input data is transmitted to the web module 19. The validity of the user input data may be performed by the web browser 20 and/or the web module 19. At step S4-5, the web module 19 receives the user input MDN and retrieves the stored online account data 51 associated with the user input MDN, including the securely stored cryptography key 53 for that user's online account. At step S4-7, the web browser 20 displays a subsequent web page received from the web module 19 to prompt the user for input of a passcode as generated by the user's mobile device 3, within a predetermined amount of time (for example a window of two minutes from display of the subsequent web page by the web browser). FIG. 5b schematically illustrates an example web page 63 confirming the user input MDN and prompting for input of a passcode in an input box 64. The web page can also include code or processing instructions to configure the browser to monitor for the authentication timeout at step S4-9. If the predetermined amount of time has not elapsed, the web browser 20 determines if the user input passcode has been received at step S4-11, and if not, continues to monitor for the user input within the predetermined time window. If at step S4-9, the web browser 20 determines that the user has not input a passcode within the predetermined time window, then the web browser may notify the user that the authentication input step has timed out and the user may be directed back to the initial registration web page to restart the registration process.

As discussed above, the user is prompted to enter a passcode that is generated by the cryptography module 57 in the wallet application module 8 of the user's mobile device 3. The user may initiate the passcode generation process by launching the wallet application module 8 at step S4-13 in response to the prompt at step S4-7. Alternatively, the user may use the wallet application module 8 to generate a passcode at any suitable time before receiving the prompt at step S4-7, once the user has set an application issuer PIN at step S3-15 and a mobile payment has been activated at S3-21. FIG. 6a shows an example user interface 81 of the user's mobile device 3 for enabling the user to launch the wallet application module 8 by selection of a respective application icon 82 displayed by the handset operating system 28. Many other forms of user interface are possible depending on the particular mobile device used to implement the present embodiment. After the user has launched the wallet application module 8, the mobile device 3 receives, at step S4-15, user selection of a menu option to generate a passcode for online account registration. In the example shown in FIG. 4b, a “main menu” wallet screen 83 is displayed by the mobile device 3 to the user, providing a plurality of user selectable options for the electronic wallet. The user scrolls through the list of displayed options to highlight 84 and selects a desired menu option. In response to selection of the option to generate a passcode, the mobile device 3 displays an application issuer PIN input wallet screen 85 as shown in FIG. 4c to prompt for user input of the application issuer PIN into an input field 86. At step S3-17, the wallet application module 8 can then check the user input PIN against the stored application issuer PIN that was set previously at step S3-15 to verify that the user is authorized to access the wallet application module 8 to generate a passcode. Once the user input PIN is verified, an authorization validation flag is set in the wallet application module 8.

At step S4-19, the wallet application module 8 validates that the authorization validation flag is set and then uses the cryptography module 57 to generate a passcode based on the encryption key 53 (that is also stored on the web module 19 in a secure manner) as discussed above. At step S4-21, the generated passcode is displayed by the mobile device 3 to the user for a predetermined amount of time (for example one minute from initial display of the generated passcode). The wallet application module 8 monitors the amount of time that the passcode has been displayed to the user at step S4-23, and once the predetermined amount of time has passed, the wallet application module 8 displays, at step S4-25, a notification message to the user that the display operation has timed out. Processing may then return to step S4-17 to prompt the user to reenter the application issuer PIN in order to restart the process to generate a new one time passcode.

Returning now to step S4-11, as indicated by the dashed line from step S4-21, the web browser 20 receives user input of the generated passcode and transmits the user input passcode to the web module 19. In response to receipt of the user input passcode, the cryptography module 55 in the middleware server 16 is used to recreate a passcode, at step S4-27, using the retrieved encryption key 53 that is stored securely in the web module (which is the same as the encryption key 53 stored securely in the mobile device 3). At step S4-29, the web module 19, functioning as a user validator, compares the received user input passcode to the recreated passcode, and if it is determined at step S4-31 that the user input passcode matches the recreated passcode, then the user input passcode is determined to be valid. It is appreciated that in an alternative embodiment, the web module 19 may instead use the cryptography module 55 to generate and securely store a passcode for each online account prior to prompting the user to input a passcode generated on the mobile device at step S4-7. The online account registration process continues to step S4-33 where a further web page is transmitted to and displayed by the web browser 20 to prompt the user to set up a security question and answer for the online account. FIG. 5c schematically illustrates an example web page 65 confirming the user's trust phrase 66 (as previously provided by the user at step S3-15 and transmitted to the middleware server 16 at step S3-17) and prompting for input of a security answer in an input box 67. The user input security answer is then transmitted to the web module 19 and stored in the online account data 51 for that user. In this embodiment, a further subsequent registration web page is transmitted to the web browser 20 to prompt the user to enter additional anti-phishing information at step S4-35. FIG. 5d schematically illustrates an example web page 68 prompting for input selection of an image 69 for the online account, as well as user input of a username 70 which may be used to access the online account instead of the user's MDN. The user input additional information is then transmitted to the web module 19 and stored in the online account data 51 for that user to complete the online registration process.

It will be understood that embodiments of the present invention are described herein by way of example only, and that various changes and modifications may be made without departing from the scope of the invention.

In the embodiment described above, the mobile payment account is provisioned on a mobile handset which communicates with the account management system via a cellular telephone network. Instead of a mobile handset, other portable electronic devices configured for contactless payment with a merchant electronic POS, and having suitable input and display means, may carry out the functionality of generating a passcode for online registration of a user account, as described in the above embodiment. Additionally, the portable electronic device is configured to communicate with the account activation system via any other form of communication channel instead of or in addition to the above discussed over the air channels, such as a wired or wireless network connection, a Bluetooth connection, or the like. Alternatively, the mobile payment account data is provisioned on the portable electronic device by data transfer via any suitable data communication path or by way of a computer readable medium.

In the embodiment described above, the registration process involves a sequence of separate registration web pages communicated from the web module to the computing device. Instead of separate web pages, the web browser on the computing device may be configured to open a secure communication session with the web module, and to communicate information to be displayed and user input information therebetween.

In the embodiment described above, the user is prompted to enter an MDN into an input field of an online account registration web page, which information is used to identify an online account created for the user on the web module. In an alternative embodiment, the web module may instead be configured to create a pre-established online account for the user including a pre-established username, as well as additional information associated with the user that is available to the web module, such as the user's MDN and trusted phrase received from the middleware server. In this alternative embodiment, the user can then use the web browser to log in to the pre-registered account using the pre-registered user name, for example as illustrated in the exemplary web page in FIG. 7a. FIG. 7b shows a subsequently transmitted and displayed exemplary web page confirming the user's online account details after a successful login. The web browser can then display a further web page as shown in FIG. 7c to prompt for user input of a generated passcode, as described in the embodiment above. FIG. 7d shows an exemplary web page that can be displayed to the user following input of a valid user input passcode and successful website login to the pre-registered online account.

In the embodiment described above, the mobile payment system facilitates secure activation and integration of a mobile payment account sub-system and an online banking sub-system via a web browser in communication with a web module over the Internet. In alternative embodiments, the account management system may instead, or additionally, provide for communication with a user over other alternate channels (separate from the network through which payment transactions are conducted), so as to facilitate the secure activation of the online account associated with a mobile device configured for contactless payment operations. For example, the account management system may instead or additionally comprise a automated voice detection sub-system for communication by the user of the generated passcode via a telephone.

In the embodiment described above, the mobile device stores a plurality of application modules (also referred to as computer programs or software) in memory, which when executed enable the mobile device to implement embodiments of the present invention as discussed herein. The software is stored in a computer program product and loaded into the mobile device using any known instrument, such as removable storage disk or drive, hard disk drive, or communication interface, to provide some examples.

In the embodiments described above, the account management system is described as a separate entity to the payment account issuer and the associated payment processing system. The account management system can be provided as an integral part or sub-system of the payment account issuer and/or payment processing system.

Alternative embodiments may be envisaged, which nevertheless fall within the spirit and scope of the following claims.

What is claimed is:

1. A mobile payment account system comprising:
a mobile device configured for contactless payment operations from a mobile payment account and including:
a secure element storing a wallet application module, data defining a first encryption key, and data associated with the mobile payment account; and
a first passcode generator adapted to generate a first passcode based at least on the first encryption key; and
an online account server including:
a memory storing online account data defining a user account associated the mobile device, the online account data comprising data defining a second encryption key;
a communication interface adapted to receive user input data identifying the passcode generated by the mobile device;
a second passcode generator adapted to generate a second passcode based at least on the second encryption key; and
a user validator adapted to compare the first passcode to the second passcode in a registration process to register the user account.

2. The system of claim 1, wherein the passcode generator of the mobile device displays the generated first passcode for a predetermined amount of time.

3. The system of claim 1, wherein the mobile device is a mobile handset.

4. The system of claim 3, wherein the mobile device is associated with a unique identifier and the unique identifier is a Mobile Directory Number (MDN).

5. The system of claim 1, wherein the data associated with the mobile payment account comprises a Personal Identification Number (PIN).

6. The system of claim 1, wherein the data associated with the mobile payment account comprises biometric data.

7. The system of claim 1, wherein the first encryption key is the same as the second encryption key.

8. The system of claim 1, wherein the first and second passcode generators generate the respective first and second passcodes based on additional information associated with a time-based element.

9. The system of claim 1, wherein the first and second passcode generators generate the respective first and second passcodes based on additional information associated with a hardware identifier of the mobile device.

10. The system of claim 1, wherein the first and second passcodes are numeric, alphabetic symbols, non-alphanumeric symbols, or a combination thereof.

11. The system of claim 1, wherein a user validator verifies the user account associated with the mobile device when the generated passcode matches the recreated passcode.

12. The system of claim 1, wherein the wallet application module, data defining an encryption key, and the data associated with the mobile payment account are transmitted to the secure element of the mobile device by a secure communication channel.

13. The system of claim 1, wherein the secure element is an embedded secure memory chip or a Universal Integrated Circuit Card (UICC) secure element.

14. The system of claim 1, wherein the secure element is a peripheral memory device or a micro Secure Digital card.

15. The system of claim 1, further comprising a computing device including a web browser for communication with the online account server.

16. The system of claim 15, wherein the web browser receives a web page including an input field for receiving a user input passcode.

17. The system of claim 16, wherein the web page enables user input of the passcode within a predetermined time window.

18. The system of claim 17, wherein the mobile device is the computing device.

19. An online account server in the mobile payment account system of claim 1, comprising:
a memory storing online account data defining a user account associated with a mobile device, the online account data comprising data defining a second encryption key;
a communication interface adapted to receive user input data identifying the passcode generated by the mobile device;
a second passcode generator adapted to generate a passcode based at least on the second encryption key; and
a user validator adapted to compare the received generated passcode to the passcode generated by the second passcode generator, in a registration process to register the user account.

20. A computer-implemented method of registering an online account associated with a mobile device configured for contactless payment operations in a mobile payment account system, the method comprising:
storing online account data defining a user account associated a mobile device;
receiving user input data identifying a first passcode generated by the mobile device based at least on an encryption key stored securely in the mobile device;
generating a second passcode based at least on an encryption key stored in an online account server;
comparing the first passcode to the second passcode to determine a match; and
registering the online account when a match is determined.

21. A computer implemented method of registering an online account associated with a mobile device configured for contactless payment operations in a mobile payment account system, the method comprising:
initiating a registration process to register an online account associated with a mobile device;
receiving user input data identifying a first passcode generated by the mobile device; and
transmitting the first passcode to an online account server for registering the online account when the online account server determines that the first passcode matches a second passcode generated by the online account server based at least on an encryption key stored in the online account server.

22. A computer program comprising program code arranged to perform a method of registering an online account associated with a mobile device configured for contactless payment operations in a mobile payment account system, comprising:
computer-implementable instructions to store online account data defining a user account associated a mobile device;
computer-implementable instructions to receive user input data identifying a first passcode generated by the mobile device based at least on an encryption key stored in the mobile device;
computer-implementable instructions to generate a second passcode based at least on an encryption key stored in an online account server;
computer-implementable instructions to compare the first passcode to the second passcode to determine a match; and
computer-implementable instructions to register the online account when a match is determined.

23. A computer program comprising program code arranged to perform a method of registering an online account associated with a mobile device configured for contactless payment operations in a mobile payment account system, comprising:
computer-implementable instructions to initiate a registration process to register an online account associated with a mobile device;
computer-implementable instructions to receive user input data identifying a first passcode generated by the mobile device; and
computer-implementable instructions to transmit the first passcode to an online account server for registering the online account when the online account server determines that the first passcode matches a second passcode generated by the online account server based at least on an encryption key stored in the online account server and the received unique identifier associated with the mobile device.
